(19) United States
(12) Patent Application Publication
(10) Pub. No.: US 2026/0032065 A1
(43) Pub. Date: Jan. 29, 2026

(54) Reporting Random Access Partition Information

(71) Applicant: Telefonaktiebolaget LM Ericsson (publ), Stockholm (SE)

(72) Inventors: Tahmineh Torabian Esfahani, Sollentuna (SE); Ali Parichehrehteroujeni, Linköping (SE); Marco Belleschi, Solna (SE); Angelo Centonza, Granada (ES); Johan Rune, Lidingö (SE)

(21) Appl. No.: 18/996,214

(22) PCT Filed: Jul. 25, 2023
(86) PCT No.: PCT/SE2023/050755

§ 371 Date: Jan. 17, 2025

Related U.S. Application Data
(60) Provisional application No. 63/396,129, filed on Aug. 8, 2022.

(51) Int. Cl. H04W 74/0838; H04L 43/062

(52) U.S. Cl. CPC H04W 74/0838; H04L 43/062

(57) ABSTRACT

Embodiments include methods for a user equipment (UE) configured to operate in a radio access network (RAN). Such methods include performing a random access (RA) procedure to a cell in the RAN. The RA procedure is performed using resources selected from a RA resource partition based on one or more of the following: a feature or feature combination that triggered the RA procedure, and one or more network slices, slice groups, or slice types associated with the RAN. Such methods include logging and storing in a RA report identifiers of at least one of the following: the RA partition, the feature or feature combination that triggered the RA procedure, and the one or more network slices, slice groups, or slice types associated with the RAN. Such methods include sending the RA report to a RAN node. Other embodiments include complementary methods for a RAN node.

### TECHNICAL FIELD

The present disclosure relates generally to wireless networks, and more specifically to techniques for improving the capability of a radio access network (RAN) to diagnose causes of events or operations reported by user equipment (UEs), particularly ones associated with random access problems.

### BACKGROUND

Currently the fifth generation (5G) of cellular systems is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in the EPC via respective S1-C interfaces and to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Self-Organizing Networks (SON) is an automation technology used to improve the planning, configuration, management, optimization, and healing of RANs. SON functionality can broadly be categorized as either self-optimization or self-configuration. Self-optimization employs UE and network measurements to auto-tune the RAN. This occurs when RAN nodes are in an operational state, after the node's RF transmitter interface is switched on. Self-configuration operations include optimization and adaptation, which are generally performed before the RAN nodes are in operational state.

Self-configuration and self-optimization features for NR networks are described in 3GPP TS 38.300 (v16.5.0) and for LTE networks in 3GPP TS 36.300 (v16.5.0). These features include dynamic configuration, automatic neighbor relations (ANR), mobility load balancing (MLB), mobility robustness optimization (MRO), random access channel (RACH) optimization, capacity and coverage optimization (CCO), and mobility settings change.

Seamless mobility is a key feature of 3GPP radio access technologies (RATs). In general, a RAN (e.g., NG-RAN) configures a UE to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE to declare radio link failure (RLF) or handover failure (HOF). This can occur before the UE sends a measurement report in a source cell, before the UE receives a handover command to a target cell, shortly after the UE executes a successful handover to the target cell, or upon a HOF to the target cell (e.g., upon expiry of timer T304, started when the UE starts synchronization with the target cell).

An RLF reporting procedure was introduced as part of the mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). 3GPP Rel-17 introduced a successful handover report (SHR) whereby a UE reports various information about a successful handover to a target cell. Both RLF reports and SHRs can include information about the UE's random access towards the target cell.

RACH configuration has significant impact on user experience and overall network performance. RACH settings affect collision probability, setup delays, data resuming delays, handover delays, transition delays (e.g., from RRC_INACTIVE state), and beam failure recovery (BFR) delays. In addition, a UE performing random access (RA) on the most suitable downlink (DL) beam avoids unnecessary power ramping and failed RA attempts. This reduces interference in the network as well as delay experienced by the user and UE energy consumption.

Accordingly, one goal of the SON RACH optimization is to automatically set various network parameters that affect RACH performance. This is done by the network collecting RA (or RACH) reports from UEs and by RAN nodes (e.g., gNBs) exchanging parameters used on their respective physical RACH (PRACH) channels, on which UEs transmit initial RA messages called preambles. RACH optimization also involves conflict detection and resolution among neighboring cells served by different RAN nodes. RACH parameters to be optimized include configuration/resource unit allocation, preamble partitioning among different uses, backoff parameters, and transmit power control (TPC) parameters.

In NR Rel-17, a new feature allows UEs to use dedicated RACH resources depending on various factors, such as the feature(s) or service(s) that triggered the UE's RA procedure. Put differently, RA resources will be partitioned among different use cases such as reduced capability (RedCap) UEs, small data transmission (SDT), network slicing, etc. RA resource partitions in a cell may occur over time, frequency, and/or code domains, and can be changed over time according to UE distribution in the coverage area of the cell. At any given time, a particular UE uses a specific RA resource depending on the cell's RA resource partitioning and the UE's capabilities and current configuration.

### SUMMARY

However, current RACH optimization does not consider RA resource partitioning based on use cases, features, services, or network slicing. Furthermore, current RA reporting by UEs does not include information about feature-based RA, such as that a RA on a specific RACH partition was triggered due to a service request for one or more network slices. Without such information, the RAN has limited or no visibility to conditions that triggered selection of a specific RACH partition and that may have led to RACH resource congestion and/or collision. As such, any RACH optimization is sub-optimal.

An object of embodiments of the present disclosure is to improve reporting of RA information by UEs and to improve use of reported RA information by a RAN, such as by providing, enabling, and/or facilitating solutions to overcome exemplary problems summarized above and described in more detail below.

Embodiments include methods (e.g., procedures) for a UE configured to operate in a RAN (e.g., E-UTRAN, NG-RAN).

These exemplary methods include performing a random access (RA) procedure to a cell in the RAN. The RA procedure is performed using resources selected from a RA resource partition based on one or more of the following: a feature or feature combination that triggered the RA procedure, and one or more network slices, slice groups, or slice types associated with the RAN. These exemplary methods include logging and storing in a RA report identifiers of at least one of the following: the RA partition, the feature or feature combination that triggered the RA procedure, and the one or more network slices, slice groups, or slice types associated with the RAN. These exemplary methods include sending the RA report to a RAN node.

In some embodiments, these exemplary methods also include receiving from the RAN a RA configuration that defines a plurality of RA resource partitions for the cell, and selecting the RA resource partition from the plurality of RA resource partitions, based on one or more of the following: the feature or feature combination that triggered the RA procedure, and the one or more network slices, slice groups, or slice types, which map to the feature or feature combination that triggered the RA procedure.

In some of these embodiments, the plurality of RA resource partitions include the following:
at least one RA resource partition of contention-based preamble resources (CBPR) that are dedicated to one or more network slices, slice groups, or slice types associated with the RAN; and
one or more of the following: at least one other partition of CBPR, and at least one partition of contention-free preamble resources (CFPR).

In some embodiments, the UE logs and stores in the RA report respective priorities of one of the following: the feature that triggered the RA procedure, or a plurality of features comprising the feature combination that triggered the RA procedure. In other embodiments, the UE logs and stores in the RA report a highest priority among respective priorities of a plurality of features comprising the feature combination that triggered the RA procedure.

In some embodiments, the identifier of the RA resource partition (i.e., in the RA report) includes the following: an index of an initial RA preamble of the RA resource partition, and a number of RA preambles included in the RA resource partition. In some embodiments, the identifier of the feature or feature combination (i.e., in the RA report) is a bit field comprising a plurality of bits corresponding to a respective plurality of features or services, with each bit having a value indicating whether the RA procedure was triggered by the corresponding feature or service.

In some embodiments, these exemplary methods also include receiving from the RAN node a request for RA reports. The RA report is sent in response to the request. In some of these embodiments, the request is an RRC UEInformationRequest message and the RA report is selectively included in a responsive RRC UEInformationResponse message based on the RA report being related to one of the following:
a network slice, slice group, or slice type supported by the RAN node; or
the network slice in which the UE receives the RRC UEInformationRequest message.

In some of these embodiments, these exemplary methods also include sending to the RAN node an indication of availability of the RA report. The request is received in response to the indication of availability. In some variants of these embodiments, sending the indication of availability is based on the RA report being related to a network slice that is or will be used by the UE to communicate with the RAN node.

In some embodiments, the RAN node serves the cell in which the UE performed the RA procedure.

Other embodiments include exemplary methods (e.g., procedures) for a RAN node configured to serve UEs via a cell. In general, these exemplary methods can be complementary to the exemplary methods for a UE summarized above.

These exemplary methods can include receiving, from a UE, a RA report including identifiers of at least one of the following:
a RA resource partition that includes RA resources used by the UE to perform a RA procedure to the cell;
a feature or feature combination that triggered the RA procedure by the UE to the cell, and
one or more network slices, slice groups, or slice types associated with the RAN.
   These exemplary methods also include, based on the RA report, adjusting one or more RA resource partitions associated with the cell.

In some embodiments, these exemplary methods also include transmitting in the cell (e.g., via broadcast SI) a RA configuration that defines a plurality of RA resource partitions for the cell, including the RA resource partition identified in the RA report. In some of these embodiments, the RA resource partition identified in the RA report is associated with one or more of the following:
the feature or feature combination that triggered the RA procedure by the UE, and
the one or more network slices, slice groups, or slice types, which map to the feature or feature combination that triggered the RA procedure by the UE.

In some of these embodiments, the plurality of RA resource partitions include the following:
at least one RA resource partition of contention-based preamble resources (CBPR) that are dedicated to one or more network slices, slice groups, or slice types associated with the RAN: and
one or more of the following: at least one other partition of CBPR, and at least one partition of contention-free preamble resources (CFPR).

In some embodiments, the RA report also includes one of the following:
respective priorities of the one or more features or services for which the UE is accessing the RAN; or
a highest priority among the one or more features or services for which the UE is accessing the RAN.

In some embodiments, the identifier of the RA resource partition includes the following: an index of an initial RA preamble of the RA resource partition, and a number of RA preambles included in the RA resource partition.

In some embodiments, the RA report includes respective priorities of one of the following: the feature that triggered the RA procedure, or a plurality of features comprising the feature combination that triggered the RA procedure. In other embodiments, the RA report includes a highest priority among respective priorities of a plurality of features comprising the feature combination that triggered the RA procedure.

In some embodiments, the identifier of the feature or feature combination is a bit field comprising a plurality of bits corresponding to a respective plurality of features or services, with each bit having a value indicating whether the RA procedure was triggered by the corresponding feature or service.

In some embodiments, these exemplary methods also include sending to the UE a request for RA reports. The RA report is received from the UE in response to the request. In some of these embodiments, the request is an RRC UEInformationRequest message and the RA report is selectively received in a responsive RRC UEInformationResponse message based on the RA report being related to one of the following: a network slice, slice group, or slice type supported by the RAN node; or the network slice in which the RAN node sends the RRC UEInformationRequest message.

In some of these embodiments, these exemplary methods also include receiving from the UE an indication of availability of the RA report. The request is sent to the UE in response to the indication of availability. In some of these embodiments, receiving the indication of availability is based on the RA report being related to a network slice that is or will be used by the UE to communicate with the RAN node.

In some embodiments, adjusting one or more LBT configuration parameters for UEs based on the RA information can include the RAN node performing the following operations, labelled with corresponding sub-block numbers:
determining that the RA resource partition identified in the RA report is experiencing excessive load due to RA procedures associated with one or more of the following indicated in the RA report; the feature or feature combination that triggered the RA procedure by the UE to the cell, and the one or more network slices, slice groups, or slice types; and
detecting a condition comprising possible conflicts, collisions, and/or contention among UEs performing RA procedures using RA resources of the RA resource partition identified in the RA report.

In some of these embodiments, adjusting one or more LBT configuration parameters for UEs based on the RA information can also include the RAN node performing the following operations, labelled with corresponding sub-block numbers:
reallocating RA resources of the cell to increase RA resources included in the first RA resource partition; and
adjusting PRACH configurations used in the cell.

In some of these embodiments, the RA report is received by a CU of the RAN node and these exemplary methods also include the CU forwarding the RA report to a DU of the RAN node. In such case, adjusting one or more RA resource partitions is performed by the DU based on the RA report.

In some variants of these embodiments, the condition is detected by the DU based on a plurality of RA reports received by the CU and forwarded to the DU. Also, adjusting one or more RA resource partitions associated with the cell based on the RA report also includes the operations, where the DU can send to the CU indications of one or more of the following:
the RA resource partition identified in the RA report, in which the condition was detected;
a UE RACH configuration associated with the RA resource partition identified in the RA report;
a cell physical RACH (PRACH) configuration associated with the RA resource partition identified in the RA report; and
load information for the RA resource partition identified in the RA report.

In some further variants of these embodiments, the load information includes one or more of the following: average number of detected preambles per PRACH occasion, number of RA preambles detected during each of a most recent plurality of PRACH occasions, number of PRACH occasions in which RA preambles were detected, and number of detected RA preambles that could not be processed due to capacity constraints.

In some embodiments, these exemplary methods also include receiving, from a second RAN node, RA information related to one or more neighbor cells adjacent to the cell. The RA information for each neighbor cell includes one or more of the following:
a configuration of a plurality of RA resource partitions used in the RA resource partition identified in the RA report;
load information related to the plurality of RA resources partitions; and
a mapping between the plurality of RA resource partitions and a corresponding plurality of one or more of the following: features; services; and network slices, slice groups, or slice types.
   In such embodiments, adjusting the one or more RA resource partitions associated with the cell is further based on the RA information received from the second RAN node.

Other embodiments include UEs (e.g., wireless devices) and RAN nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs and RAN nodes to perform operations corresponding to any of the exemplary methods described herein.

These and other embodiments described herein can provide various advantages, benefits, and/or solutions to problems. For example, based on RA information logged and reported by a UE, the RAN can determine whether and how to reconfigure RA resource partitions directly associated with one or more network slices and/or features, as well as RA resource partitions indirectly associated with one or more network slices and/or features due to selection by UEs to perform RA associated with the one or more network slices and/or features. In this manner, the RAN can adjust and/or optimize RA resource partitions in various cells of the RAN, including reallocating resources among multiple RA resource partitions for a cell (e.g., to balance load) and coordinate with other RAN nodes serving neighbor cells to reduce and/or avoid contention and/or conflict among RA resources.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 is a block diagram illustrating self-organization network (SON) functionality.

FIG. 5 shows an exemplary ASN.1 data structure for a RACH-ConfigCommon information element (IE).

FIG. 6 shows exemplary RA resource partitioning for a cell, according to various embodiments of the present disclosure.

FIG. 7 shows an exemplary ASN.1 data structure for an RA-ReportList-r16 IE, according to various embodiments of the present disclosure.

FIG. 8 shows a flow diagram of an exemplary method for a UE (e.g., wireless device), according to various embodiments of the present disclosure.

FIG. 9 shows a flow diagram of an exemplary method for a RAN node (e.g., base station, eNB, gNB, ng-eNB, etc.), according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

As briefly mentioned above, current approaches used for LTE and NR self-configuration/self-optimization features are reactive based on current network conditions and/or current UE traffic load. In other words, the current approaches adjust coverage, capacity, load, etc. in response to inputs indicating onset of a degradation in network performance, such as due to increased interference, resource utilization, user traffic, etc. However, there can be significant delays between the adjustments and their desired effects, during which the degradation in network performance will continue. This is discussed in more detail after the following description of NR network architecture and protocols.

FIG. 2 shows a high-level view of an exemplary 5G network architecture, including an NG-RAN (299) and a 5GC (298). As shown in the figure, the NG-RAN can include gNBs (e.g., 210a,b) and ng-eNBs (e.g., 220a,b) that are interconnected via respective Xn interfaces. The gNBs and ng-eNBs are also connected via NG interfaces to the 5GC, more specifically to the Access and Mobility Management Functions (AMFs, e.g., 230a,b) via respective NG-C interfaces and to User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the LTE radio interface. Unlike conventional LTE eNBs, however, ng-eNBs connect to the 5GC via the NG interface. Each of the gNBs and ng-eNBs can serve a geographic coverage area including one or more cells (e.g., 211a-b and 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE. NR SCS can range from 15 to 240 kHz, with even greater SCS considered for future NR releases.

As briefly mentioned above, NR networks also provide coverage via “beams.” In general, a downlink (DL) “beam” is a coverage area of a network-transmitted RS that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

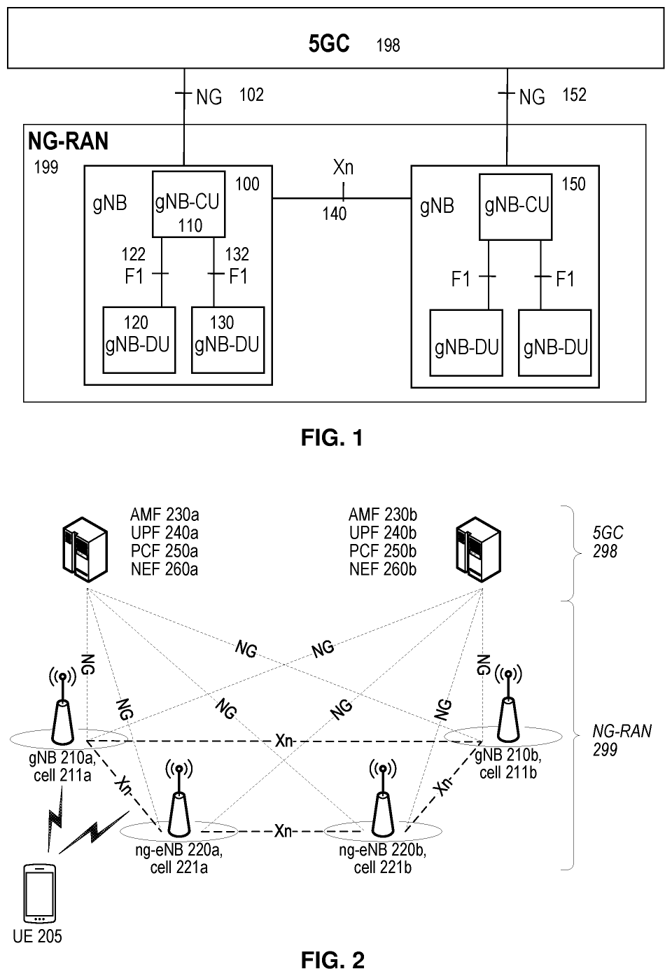

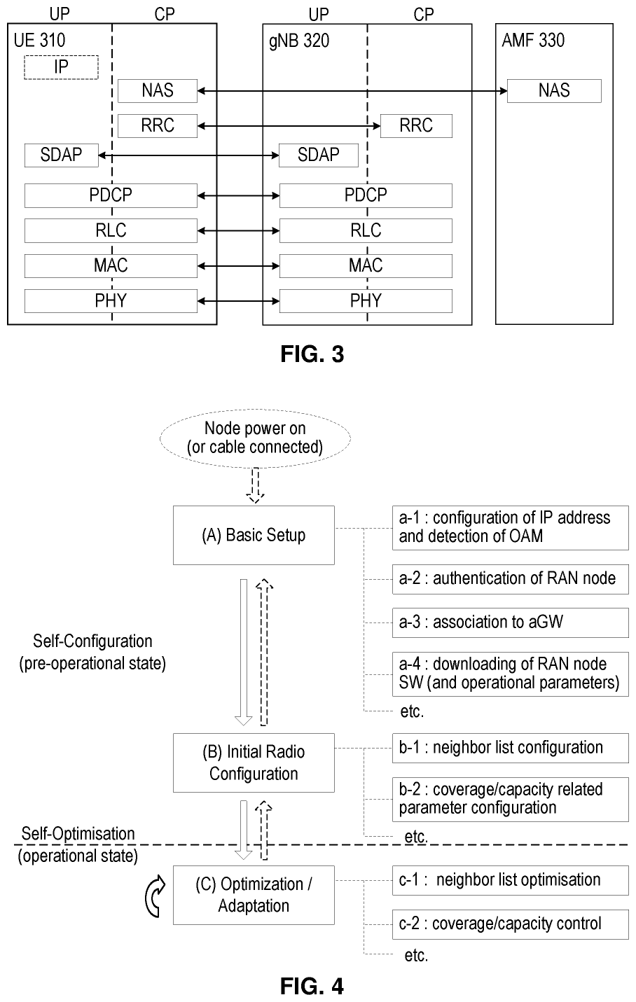

FIG. 3 shows an exemplary configuration of NR user plane (UP) and control plane (CP) protocol stacks between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On the CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

FIG. 4 is a block diagram illustrating self-organization network (SON) functionality. As briefly mentioned above, SON is an automation technology used to improve the planning, configuration, management, optimization, and healing of mobile RANs. As briefly mentioned above and further illustrated in FIG. 4, SON functionality can broadly be categorized as either self-optimization or self-configuration.

Self-configuration is a pre-operational process in which newly deployed RAN nodes (e.g., eNBs or gNBs) in a pre-operational state are configured by automatic installation procedures to get the necessary basic configuration for system operation. Pre-operational state generally refers to the time when the node is powered up and has backbone connectivity until the node's RF transmitter is switched on. Self-configuration operations in pre-operational state include (A) basic setup and (B) initial radio configuration, which include the following sub-operations shown in FIG. 4:
(a-1) Configuration of IP address and detection of operations administration and maintenance (OAM);
(a-2) Authentication of RAN node;
(a-3) Associate to access gateway (aGW);
(a-4) Downloading of RAN node software (SW) and operational parameters;
(b-1) Neighbor list configuration; and
(b-2) Coverage/capacity-related parameter configuration.

Self-optimization is a process in which UE and network measurements are used to auto-tune the network. This occurs when the nodes are in operational state, which generally refers to when a node's RF transmitter interface is switched on. Self-configuration operations include optimization and adaptation, which includes the following sub-operations shown in FIG. 4:
(c-1) Neighbor list optimization; and
(c-2) Coverage/capacity control.

Self-configuration and self-optimization features for LTE networks are described in 3GPP TS 36.300 (v16.8.0) section 22.2 and for NR networks in 3GPP TS 38.300 (v16.9.0) section 15. These include dynamic configuration, automatic neighbor relations (ANR), mobility load balancing (MLB), mobility robustness optimization (MRO), RACH optimization, and support for energy savings.

MLB involves coordination between two or more RAN nodes to optimize the traffic loads of their respective cells, thereby enabling a better use of radio resources available in a geographic area among served UEs. MLB can involve load-based handover of UEs between cells served by different nodes, thereby achieving “load balancing.”

CCO involves coordination between two or more RAN nodes to optimize the coverage and capacity offered by their respective cells. For example, a reduced coverage and/or capacity in a cell served by a first RAN node can be compensated by an increase in the coverage and/or capacity of neighboring cell served by a second RAN node.

Mobility settings change involves two RAN nodes negotiating a mutually agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. For example, a setting change for a handover trigger parameter can expand or shrink the UE's observed coverage area of a serving cell, thereby causing the UE to request a handover to a neighbor cell having a higher measured signal strength and/or quality.

RACH configuration has significant impact on user experience and overall network performance. RACH settings affect collision probability, setup delays, data resuming delays, handover delays, transition delays (e.g., from RRC_INACTIVE state), and beam failure recovery (BFR) delays. In addition, a UE performing random access (RA) on the most suitable downlink (DL) beam avoids unnecessary power ramping and failed RA attempts. This reduces interference in the network as well as delay experienced by the user and UE energy consumption.

Accordingly, one goal of the SON RACH optimization function is to automatically set various network parameters that affect performance of RACH. This is done by collecting RA (or RACH) reports from UEs and by RAN nodes (e.g., gNBs) exchanging parameters they use on respective physical RACH (PRACH) channels, in which UEs transmit initial RA messages called preambles. RACH optimization also involves conflict detection and resolution among neighboring cells served by different RAN nodes.

The setting of RACH parameters depends on several factors including:
UL inter-cell interference from the Physical Uplink Shared Channel (PUSCH);
RACH load during to UE events that utilize RACH, such as call arrival rate, handover rate, tracking area update, RRC_INACTIVE transition rate, requests for Other SI, beam failure recovery (BRF), UE UL synchronization, etc.;
UE traffic pattern and population under the cell coverage;
UL and downlink (DL) imbalances;
UL and supplementary uplink (SUL) imbalances;
PUSCH load;
cubic metric of the preambles allocated to a cell; and
whether the cell is in high-speed mode.

Some specific goals of RACH optimization include minimizing the following:
access delays for the UEs under the coverage of popular SSBs;
delays for the UEs to request the other SI;
imbalance of UE access delays between UL and SUL channel;
BFR delays for UEs in RRC_CONNECTED; and
failed/unnecessary UE RACH attempts before success.
   Some specific RACH parameters to be optimized include configuration/resource unit allocation, preamble partitioning among different uses, backoff parameters, and transmit power control (TPC) parameters.

For the split node architecture shown in FIG. 1, a gNB-DU can report its RACH configuration per served cell to the gNB-CU, which can provide RACH configuration per served cell (e.g., for multiple gNB-DUs) to neighbor RAN nodes. This allows RAN nodes to identify whether RACH configurations of neighbor cells are optimized or whether changes are needed to achieve a better RACH coordination between neighbor cells.

Upon receiving an RRC UEInformationRequest message from a serving RAN node (e.g., gNB-CU, which handles RRC) requesting a RA report, a UE sends the requested information an RRC UEInformationResponse message. The RA report may be requested by the serving RAN node when the UE's RA was successful, and may include one or more of the following:
Indices of one more SSBs and number of RACH preambles sent per SSB, in chronological order of attempts;
frequency (e.g., ARFCN) of the one or more SSBs;
DL beam quality for each of the SSB (i.e., RSRP, RSRQ, SINR);
Indication whether each of the SSBs is above or below an rsrp-ThresholdSSB;
elapsed time from the last SSB measurement prior to SSB selection;
Number of RACH preambles sent on (normal) UL;
number of RACH preambles sent on SUL;
Total number of fallbacks from contention based random access (CBRA) to contention free random access (CFRA); and
Contention detection indication

In case the UE is arranged in dual connectivity (DC) with a master node (MN) and a secondary node (SN), the RA report can also include any of the above information pertaining to RA attempts to the SN. 3GPP TS 38.331 (v16.9.0) section 5.7.10.5 further specifies the particular information included by a UE in a RA report.

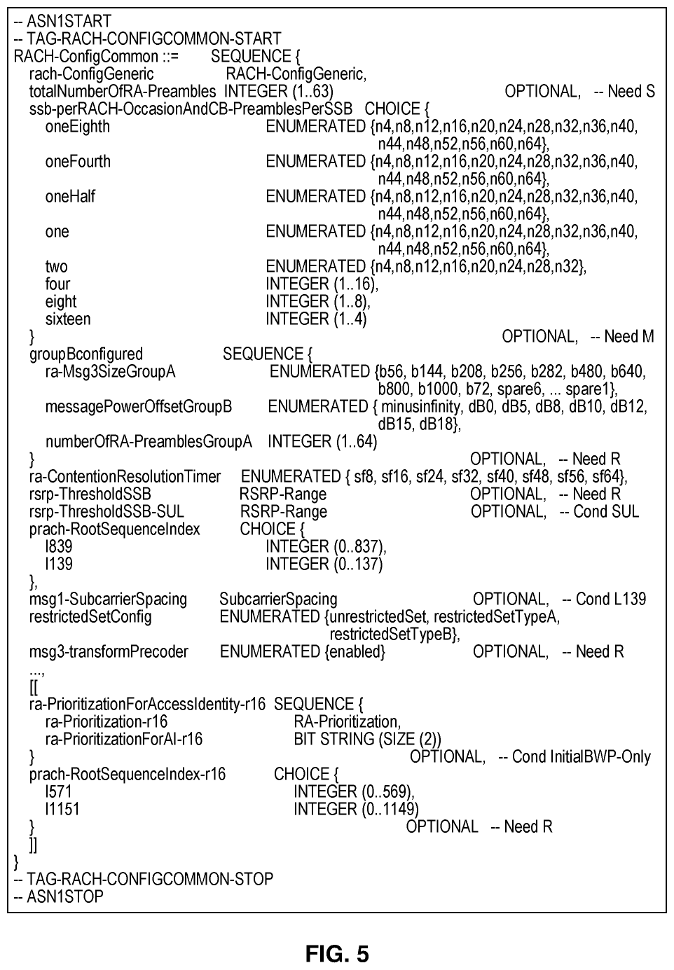

A UE transmits its initial message (i.e., preamble) during RA on a physical random-access channel (PRACH). Prior to initiation of RA, the UE lower layers (e.g., PHY) receives the following information from the higher layers (e.g., RRC):
Configuration of PRACH transmission parameters such as preamble format, time resources, and frequency resources; and
Parameters for determining a PRACH preamble sequence set, such as index to logical root sequence table, cyclic shift (CS N), set type (e.g., unrestricted, restricted set A, or restricted set B), etc.
   FIG. 5 shows an exemplary ASN.1 data structure for a RACH-ConfigCommon IE, by which a RAN node configures RACH use in a cell. This IE is broadcast in SI block 1 (SIB1). Descriptions of individual fields shown in FIG. 5 are given in 3GPP TS 38.331 (v16.9.0).

The RAN node configures the set of random-access preamble sequences the UE is allowed to use, generated from one or several root Zadoff-Chu sequences with zero correlation zone. In an NR cell, there are up to two sets of up to 64 preamble sequences available, where set 1 corresponds to higher-layer PRACH configuration using prach-ConfigurationIndex and prach-FrequencyOffset, and set 2 (if configured) corresponds to higher-layer PRACH configuration using prach-ConfigurationIndexHighSpeed and prach-FrequencyOffsetHighSpeed.

A UE determines the set of (up to) 64 preamble sequences in a cell by including, in the order of increasing cyclic shift, all the available cyclic shifts of a root Zadoff-Chu sequence with the logical index rootSequenceIndexHighSpeed (for Set 2, if configured) or with the logical index RACH_ROOT_SEQUENCE (for Set 1), where both rootSequenceIndexHighSpeed (if configured) and RACH_ROOT_SEQUENCE are broadcast as SI for the cell. In case the number of allowed preamble sequences cannot be generated from a single root Zadoff-Chu sequence, the UE obtains additional ones from root sequences with consecutive logical indices until all allowed preamble sequences are found.

To prevent PRACH collisions and/or confusion with neighbor cells, two adjacent cells should use different RACH sequence indices. To facilitate this, neighbor RAN nodes can share various PRACH information over their interfaces. Table 1 below shows the content of an exemplary E-UTRA PRACH Configuration message (or IE) sent over an Xn interface between RAN nodes (e.g., eNBs or en-gNBs). Likewise, Table 2 below shows the content of an exemplary NR PRACH Configuration List message (or IE) sent over an F1 interface between gNB-CUs and gNB-DUs.

TABLE 1

| | | | | |
|---|---|---|---|---|
| IE/Group Name | Pres. | Range | IE type/ref. | Semantics description |

| | | | |
|---|---|---|---|
| RootSequenceIndex | M | INTEGER | See section 5.7.2. in TS |
| | | (0 . . . 837) | 36.211 [26] |
| ZeroCorrelationZone | M | INTEGER | See section 5.7.2. in TS |
| Configuration | | (0 . . . 15) | 36.211 [26] |
| HighSpeedFlag | M | ENUMERATED | “true” corresponds to |
| | | (true, false, . . . ) | Restricted set and “false” to |
| | | | Unrestricted set. See section |
| | | | 5.7.2 in TS 36.211 [26] |
| PRACH- | M | INTEGER | See section 5.7.1 of TS |
| FrequencyOffset | | (0 . . . 94) | 36.211 [26] |
| PRACH- | C-ifTDD | INTEGER | See section 5.7.1. in TS |
| ConfigurationIndex | | (0 . . . 63) | 36.211 [26] |

TABLE 2

| IE/Group Name | Pres. | Range | IE type/ref. | Semantics Description |
|---|---|---|---|---|
| NR PRACH | | 0 . . . <maxnoofPrachCon- | | Length = 0 means releasing |
| Configuration | | figuration> | | of all NR PRACH |
| Item | | | | Configuration Items for |
| | | | | this UL or SUL. |
| >NR SCS | M | | ENUMERATED | The SCS of the carrier to |
| | | | (scs15, scs30, scs60, | which this PRACH |
| | | | scs120, . . . ) | Configuration Item relates, |
| | | | | i.e., Δf in Section 5.3.2 in |
| | | | | TS 38.211 [33]. The |
| | | | | values scs15, scs30, scs60 |
| | | | | and scs120 corresponds to |
| | | | | the sub carrier spacing in |
| | | | | TS 38.104 [17]. |
| | | | | NOTE: Its value may not |
| | | | | be identical to the SCS of |
| | | | | PRACH. |
| > PRACH | M | | INTEGER (0 . . . | Lowest number of |
| Frequency Start | | | maxNrofPhysicalRe- | resource blocks which can |
| from Carrier | | | sourceBlocks-1, . . . ) | be used to deliver MSG1 |
| | | | | or the preamble part of |
| | | | | MSGA, counting from the |
| | | | | start number of the |
| | | | | corresponding carrier. |
| | | | | Identical to RBₛₜₐᵣₜ RBₛₜₐᵣₜ |
| | | | | in Section 5.1.2.2.2 in |
| | | | | TS 38.214 [34] plus msg1- |
| | | | | FrequencyStart or msgA- |
| | | | | RO-FrequencyStart-r16 in |
| | | | | TS 38.331 [8]. |
| >PRACH-FDM | M | | ENUMERATED | M in Section 6.3.3.2 in |
| | | | (one, two, four, | TS 38.211 [33]. |
| | | | eight, . . . ) | |
| >PRACH | M | | INTEGER (0 . . . | See Section 6.3.3.2 in TS |
| Configuration | | | 255, . . . , 256 . . . 262) | 38.211 [33]. |
| Index | | | | |
| >SSB per RACH | M | | ENUMERATED | Number of SSBs per |
| Occasion | | | (oneEighth, | RACH occasion. Value |
| | | | oneFourth, oneHalf, | oneEight corresponds to |
| | | | one, two, four, | one SSB associated with 8 |
| | | | eight, sixteen, . . . ) | RACH occasions, value |
| | | | | oneFourth corresponds to |
| | | | | one SSB associated with 4 |
| | | | | RACH occasions, and so |
| | | | | on. |
| >CHOICE | M | | | For the case of PRACH |
| FreqDomainLength | | | | resources reserved for |
| | | | | BFR or MSG1-based SI |
| | | | | Request, L139 is always |
| | | | | used. |
| >>L839 | | | | |
| >>>L839 Info | | 1 | | |
| >>>>Root | M | | INTEGER (0 . . . 837) | See Section 6.3.3.1 in TS |
| Sequence Index | | | | 38.211 [33]. |
| >>>>Restricted | M | | ENUMERATED | See Section 6.3.3.1 in TS |
| Set Config | | | (unrestrictedSet, | 38.211 [33]. |
| | | | restrictedSetTypeA, | |
| | | | restrictedSetTypeB, | |
| | | | . . . ) | |
| >>L139 | | | | |
| >>>L139 Info | | 1 | | |
| >>>>PRACH | M | | ENUMERATED | Subcarrier Spacing of |
| SCS | | | (scs15, scs30, scs60, | PRACH, i.e., Δf_{RA} in |
| | | | scs120, . . . ) | Section 5.3.2 in TS 38.211 |
| | | | | [33]. |
| >>>>Root | M | | INTEGER (0 . . . 137) | See Section 6.3.3.1 in TS |
| Sequence Index | | | | 38.211 [33]. |
| >Zero Correlation | M | | INTEGER (0 . . . 15) | See Section 6.3.3.1 in TS |
| Zone Config | | | | 38.211 [33]. |

In NR Rel-17, a new feature allows UEs to use dedicated RACH resources depending on several factors, such as the service that triggered the UE's RA procedure. Put differently, RA resources can be partitioned among different use cases such as reduced capability (RedCap) UEs, small data transmission (SDT), network slicing, etc. RA resource partitions in a cell may occur over time, frequency, and/or code domains, and can be changed over time according to UE distribution in the coverage area of the cell. At any given time, a particular UE uses specific RA resources depending on the cell's RA resource partitioning and the UE's capabilities and current configuration. By using the RA resources associated with a specific service, feature, or UE type, the UE indicates to the RAN that it is of that specific type or is performing RA for the specific service or feature.

As an illustrative example, the RAN node may partition a cell's RA resources (e.g., time/frequency (T/F) resources, preambles, etc.) among two features that require UE indications during a RA procedure: RedCap and SDT. In such case, the cell's RA resources will have at least the following partitions:
for non-RedCap UEs which do not want to apply SDT;
for non-RedCap UEs which do want to apply SDT;
for RedCap UEs which do not want to apply SDT; and
for RedCap UEs which do want to apply SDT.

However, current RACH optimization does not consider RA resource partitioning based on use cases, features, services, or network slicing. If the RAN wants to perform RA configuration optimization for a particular network slice (which may be associated with one or more features), then the RAN needs to know whether RA reports from served UE are associated with the particular slice or another slice. However, the current RA reporting feature does not support network slice information. As such, the RAN has limited or no visibility on the conditions that triggered selection of a specific RACH partition and that may have led to RACH resource congestion and/or collision. As such, any RACH optimization is sub-optimal.

Similarly, 3GPP Rel-17 RACH optimization and conflict detection/resolution between neighbor cells served by different RAN nodes does not consider feature based PRACH configuration. In particular, RACH conflict detection/resolution does not consider the scenario in which many UEs use limited RA resources associated with a partition, causing conflict/collision. This would lead to an imbalanced RA partitioning, in which many UEs may race over limited number of RA resources allocated to a specific RA partition.

Accordingly, embodiments of the present disclosure address these problems, issues, and/or difficulties by flexible and efficient techniques in which a UE logs (or stores) and reports information associated with a RA procedure in a cell, including identifiers of network slice and/or network slice group associated with dedicated RA resources (e.g., RA partition) being used by the UE. The UE's selection of the dedicated RA resources may be based on the network slice and/or network slice group identifier(s) directly, or may be based on services and/or features for which the UE is accessing the network, with such services and/or features being associated with the network slice and/or network slice group identifier(s). In either case, the UE selection is further based on a RA resource configuration previously provided to the UE, which describes the RA resource partitions as discussed above.

In some embodiments, the UE includes in the RA report information about the feature(s) that triggered the UE's RA procedure on a specific RA resource partition. Note that this information is different from existing featureCombination field, which does not necessarily indicate the feature(s) that triggered the UE's RA procedure. This newly reported information can be used by the RAN node to optimize the combination of features per RA resource partition (e.g., which features to put together in a partition). Furthermore, this newly reported information can make the RAN aware of which features generate the most RA attempts on each RA resource partition. In this manner, the RAN is able to re-partition its RA resources when specific feature(s) impact RA performance due to overload of a partition.

In addition, embodiments enable a RAN node comprising a CU and DU to perform various operations related to RACH optimization. For example, embodiments enable the gNB-CU to adjust its own PRACH configuration associated with a RA resource partition. As an example, the gNB-CU may deduce that RA resource partitions need to be adjusted/optimized due to RA reports from UEs that reveal features and/or network slices that triggered use of a particular RA resource partition.

RA resource contention occurs when too many UEs using resources of a single RA resource partition. In other words, the resources of the RA resource partition may be inadequate for the number of UEs accessing that partition, which may cause conflict, collisions, and/or contention among the UEs. In some embodiments, the gNB-DU can inform the gNB-CU about adjustments to PRACH configurations associated with RA resource partitions. Such adjustments may be needed/performed when too many UEs perform RA procedures associated with a specific feature or a specific network slice, resulting in a shortage of RACH resources in a RA resource partition associated with the feature and/or network slice. The information provided by the gNB-DU may include one or more of the following:
cell PRACH configurations, specifically PRACH reconfigurations associated with RA resource partitions updated to resolve RA resource contention, which enable the gNB-CU to update its neighbor cell relations;
cause(s) for reconfiguration of the RA resource partition(s), e.g., excess UE access due associated with a specific feature and/or network slice;
recommended PRACH reconfigurations to resolve imbalanced RA resource partitions and/or to achieve more uniform load across multiple RA resource partitions;
an indication of one of the following mapped to the RACH configurations that may be subject to contention on RA resources: 1) one or more features: or 2) set of RA resources.

In some embodiments, the gNB-DU may also provide load information for one or more RA resource partitions, such as average number of detected preambles per PRACH occasion, number of detected preambles for each of the last N PRACH occasions per RA resource partition, number of occasions that preambles were detected, or how many detected preambles that could not be processed due to capacity constraints.

In some embodiments, the gNB-DU performs optimization of RA resource partitions (e.g., changing number of preambles allocated in each partition) based on the RA reports provided by the UEs, which indicate one or more feature and/or one or more network slices (or network slice groups) that triggered RA using a particular RACH resource partition. By combining this information with contention detected flags, the gNB-DU may deduce which RA resource partitions are subject to elevated levels of contention and/or UE load, to which the gNB-DU can allocate more RA resources (e.g., preambles). In these embodiment, the gNB-CU receives RA reports from UEs and forwards them to the relevant gNB-DU, which consumes the RA reports for RA resource partition optimization.

In other embodiments, the gNB-CU can analyze the UE RA reports indicating one or more feature and/or one or more network slices (or network slice groups) that triggered RA using a particular RACH resource partition, determines a suitable RA resource partitions for one or more gNB-DUs, and sends the determined RA resource partitions to the respective gNB-DUs. The gNB-CU can also consider load per RA resource partition or featureCombination (e.g., with the number of preamble transmissions summed across multiple RA reports from different UEs) and/or contention detected flags.

In some embodiments, the gNB-CU informs the gNB-DU to perform PRACH configuration adjustments by means of information collected from the gNB-CU or gNB-CU in the second node about detection of a possible cell contention on RA resources due to the performing RA procedure by many UEs that are allocated limited resources for specific feature(s). Such information from gNB-CU may include:
cell PRACH configurations which may allow the gNB-DU to reconfigure its own PRACH configuration to resolve the contention on RA resources; and/or
an indication of either a certain set of feature(s), featureCombination(s) or common RA resources mapped to the RACH configurations that may be subjected to contention on RA resources.

Embodiments of the present disclosure can provide various advantages, benefits, and/or solutions to problems. For example, based on RA information logged and reported by a UE, the RAN can determine whether and how to reconfigure RA resource partitions directly associated with one or more network slices and/or features, as well as RA resource partitions indirectly associated with one or more network slices and/or features due to selection by UEs to perform RA associated with the one or more network slices and/or features. In this manner, the RAN can adjust and/or optimize RA resource partitions in various cells of the RAN, including reallocating resources among multiple RA resource partitions for a cell (e.g., to balance load) and coordinating with other RAN nodes serving neighbor cells to reduce and/or avoid contention and/or conflict among RA resources.

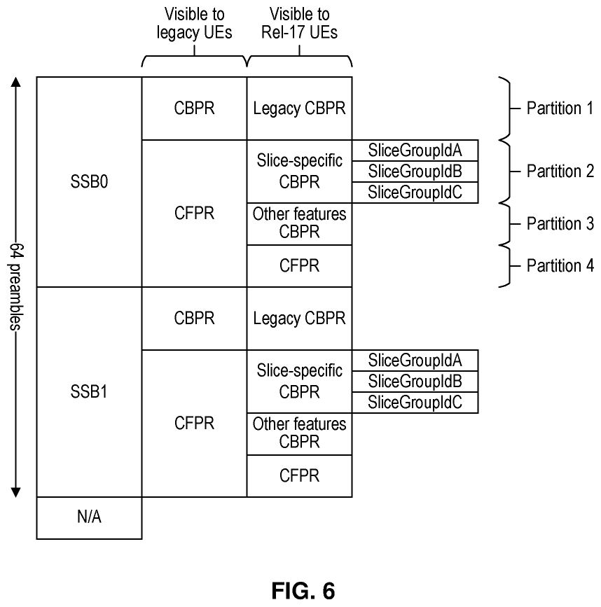

To summarize, RA resources may be partitioned into several parts where each part is associated with a particular set of features, one or more network slices, or common RA resources used by non Rel-17 UEs or other UEs using other features. FIG. 6 shows exemplary RA resource partitioning for a cell, according to various embodiments of the present disclosure. In particular, FIG. 6 shows 64 RA preambles associated with two SSBs, i.e., SSB0 and SSB1. Legacy UEs (e.g., pre-Rel-17) see the preambles associated with each SSB arranged as two partitions: one partition (or set) of contention-based preamble resources (CBPR) and one partition (or set) of contention-free preamble resources (CFPR).

In contrast, Rel-17 UEs will see the preambles arranged as the following four partitions:
Partition 1: Legacy CBPR
Partition 2: Slice-specific CBPR, including the following sub-partitions associated with specific slices/features/services:
   SliceGroupIdA: M2M (but neither RedCap nor SDT)
   SliceGroupIdB: M2M and RedCap (but not SDT)
   SliceGroupIdC: URLLC or (RedCap and SDT but not URLLC).
Partition 3: Other features CBPR; and
Partition 4: CFPR.

In some embodiments, upon performing a RA procedure, the UE logs and sends to the RAN a RA report about the performed RA procedure, as specified in 3GPP TS 38.331. In addition to conventional contents of the RA report, the UE can also include identifiers of network slice, slice group, and/or slice type associated with dedicated RA resources (e.g., RA partition) being used by the UE. The UE's selection of the dedicated RA resources may be based on the network slice, slice group, and/or slice type identifiers directly, or may be based on services and/or features for which the UE is accessing the network, with such services and/or features being associated with the network slice, slice group, and/or slice type identifiers. As an example, a network slice identifier in the RA report can identify a network slice for which the UE wanted to access services by means of performing RA using resources of the specific RA resource partition.

Alternatively or additionally, the UE may include in the RA report an identifier that allows the network to understand the service or feature for which the UE performed RA using resources of the specific RA resource partition. In some variants, the UE can include an identifier of the feature(s) that actually triggered the UE's RA using resources of the specific RA resource partition. In other variants, the UE can indicate feature priorities that the network configured for RA procedure, such as when a feature maps to more than one FeatureCombinationPreambles.

In some embodiments, the UE includes in the RA report information about a plurality of features or network slices, slice groups, or slice types that triggered the RA procedure being reported by the UE. For example, the information can include a feature combination, a list of features, or a list of network slices, slice groups, and/or slice types that triggered the RA procedure being reported by the UE.

In some embodiments, the UE can also include information about the preambles of the RA resource partition used by the UE for the RA procedure being reported. Such information may include the start preamble index and/or the number of preambles in the partition.

In some embodiments, the UE can also include priorities associated with the respective features, list entries, etc. This information may be useful to the RAN when priorities in the list have changed since the last RA procedure using this RA resource partition. The RAN is therefore able to deduce that the RA partition in question was selected due to a different priority scheme than the priority scheme in use at the time of receiving the RA report.

In other embodiments, the UE can include only the highest priority associated with the respective features, list entries, etc. This information may enable the RAN to determine which features/slices are requested by the UE and corresponding RA resource partition selected by the UE. This information can be used to balance the RA resource partitions and associate features/slices to different partitions based on the UE behaviors. In this manner, the RAN can better optimize combinations of features/slices.

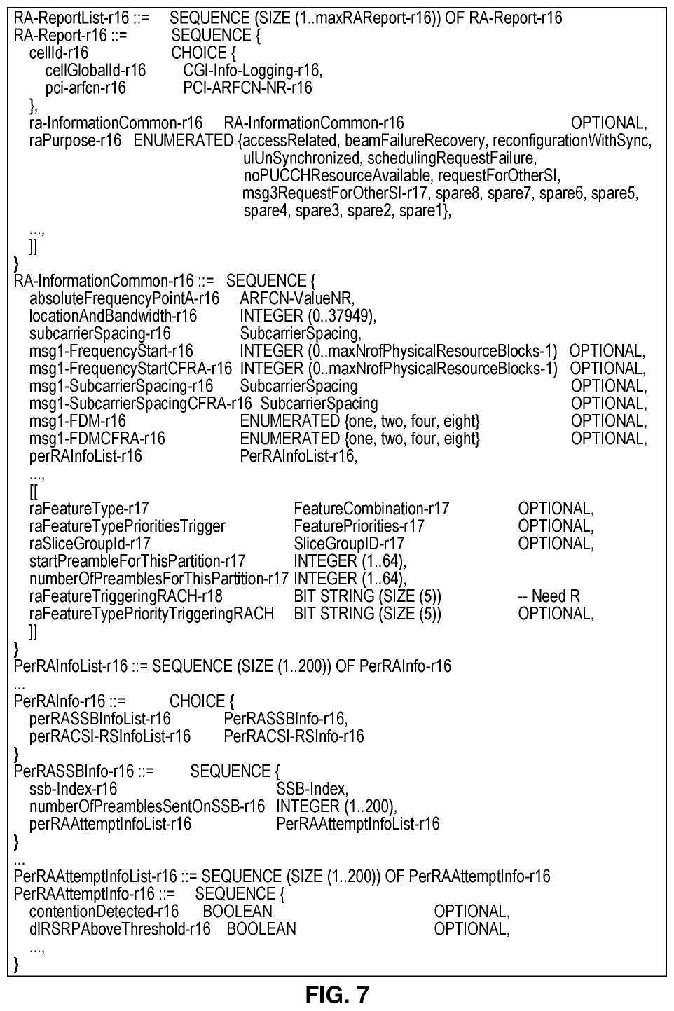

Certain embodiments can be realized as 3GPP specifications of message, information elements (IEs), and/or fields transmitted by a UE. FIG. 7 shows an exemplary ASN.1 data structure for an RRC RA-ReportList-r16 IE sent by a UE, according to some embodiments of the present disclosure. For example, this IE can be included in a UEInformationResponse message sent in response to a UEInformationRequest message from the RAN. This IE includes RA-InformationCommon-r16, which is a data structure that includes various RA-related information, including the following relevant to the embodiments disclosed herein:
raFeatureType-r17, which specifies a feature or a combination of features that triggered the UE to perform RA using resources of the specific RA resource partition;
raFeatureTypePrioritiesTrigger, which specifies priority(ies) of one or more features, based on which the UE selected resources to perform RA;
raFeatureTypeTriggeringRACH-r18, which indicates the feature(s) type that triggered the RA report. This field is a five-bit bit string with each bit corresponding to a particular feature. For example, the first/leftmost bit corresponds to RedCap, the second bit corresponds to SDT, the third bit corresponds to NSAG, the fourth bit corresponds to msg3-repititions, and the fifth bit corresponds to slicing. Multiple bits can be set to indicate multiple features running concurrently that triggered RA.
raFeatureTypePriorityTriggeringRACH, which indicates the highest-priority feature that triggered the RA report. This field is a five-bit bit string with each bit corresponding to a particular feature, with the same bit mapping as raFeatureTypeTriggeringRACH-r18 discussed above. The set bit indicates highest-priority feature.
raSliceGroupId-r17, which indicates the network slice group that triggered an RA report;
startPreambleForThisPartition-r17, which indicates the starting preamble of the RA resource partition used by the UE for the RA that triggered the RA report.
numberOfPreamblesForThisPartition-r17, which indicates the number of preambles in the RA resource partition used by the UE for the RA that triggered the RA report.

Although FIG. 7 shows the RA-InformationCommon-r16 as being part of a RA report, it can also be included in an RLF report (e.g., RLF-Report-r16 IE in the UEInformationResponse message) and/or a successful handover report (SHR).

In some embodiments, a UE may log RA information per network slice for the purpose of RA reporting. When the UE later sends an RA report to the network, the RA report will include only the RA information related to the network slice in which the UE sends the RA report (i.e., the network slice whose resources are used for transmission of the RA report).

In some embodiments, the UE can indicate availability of an RA report (e.g., in an RRCSetupComplete message) only when it has logged RA related information related to the network slice in which the UE sends the RRCSetupComplete message or will subsequently use.

In some embodiments, the UE can omit from an RA report any RA information related to network slices that are not supported by the RAN node that requests the RA report (e.g., in a UEInformationRequest message).

In some embodiments, a gNB-CU receives RA reports from UEs, including any of the information discussed above, and forwards such RA reports to the gNB-DU, which can configure/reconfigure RA resource partitions based on such information.

For example, the gNB-DU may decide that a RA resource partition (e.g., for one of its served cells) is experience excessive load due to frequent RA associated with a specific feature or to a specific network slice mapped to the RA resource partition. The gNB-DU may therefore decide to reconfigure the RA resource partitions for the cell, such as to create a dedicated RA partition for the specific feature/network slice.

Alternately, the gNB-DU forwards to another network node or function (NNF, e.g., OAM system) information needed to analyze the performance of the gNB-DU's existing RA resource partitions. The NNF analyses the performance of the gNB-DU's existing RA resource partitions, determines that a reconfiguration is necessary and/or desirable, and sends information about the reconfiguration to the gNB-DU, which may then implement the reconfiguration.

In other embodiments, the gNB-DU detects possible conflicts, collisions, and/or contention among UEs performing RA in a cell served by the gNB-DU, and sends an indication of this detected condition to the gNB-CU. The indication can one or more of the following:
an indication of one or more RA resource partitions on which the condition was detected;
a RACH configuration mapped to either a certain set of feature(s), a set of network slices, or common RA resources associated with the indicated RA resource partitions;
cell PRACH configurations associated with the indicated RA resource partitions;
load on the indicated RA resource partitions, e.g., average number of detected preambles per PRACH occasion, number of detected preambles for each of the last N PRACH occasions per RA resource partition, number of occasions that preambles were detected, or how many detected preambles that could not be processed due to capacity constraints.

For example, a gNB-DU may determine load on different RA resource partitions and PRACH resources by counting the number of preambles it detects per PRACH occasion, per PRACH resource, per set of PRACH resources, or per RA partition and time interval. The gNB-DU may also use various processing of these numbers such as averages, weighted averages, etc.

In one embodiment, gNB-CU triggers gNB-DU to perform PRACH configuration adjustments based on the information received from the gNB-DU about detection of possible conflicts, collisions, and/or contention (discussed above) and on RA-related information for neighbor cells received from other gNB-CUs or gNB-DUs.

Table 3 below shows exemplary content for an NR PRACH Configuration IE (or message), which can be sent via F1 interface between gNB-CU and gNB-DU. For example, the content of Table 3 below can be included in 3GPP TS 38.473 specification for F1 interface.

TABLE 3

| | | | | |
|---|---|---|---|---|
| | | | | Semantics |
| IE/Group Name | Pres. | Range | IE Type/ref. | Description |

| | | | |
|---|---|---|---|
| UL PRACH | M | | NR PRACH |
| Configuration | | | Configuration List |
| | | | 9.3.1.140 |
| UL PRACH Feature | O | 0 . . . <maxnoofPrachFea- | |
| Combination | | tureCombinationConfiguration> | |
| Configuration Item | | | |
| >NR PRACH | M | INTEGER (0 . . . | NR PRACH |
| Configuration for | | maxNrofFeatureCombination, . . . ) | Configuration List |
| Feature Combination | | | 9.3.1.140 |
| >>NR Feature | O | ENUMERATED | Containing |
| Combination | | (redcap, smallData, CovEnh, . . . ) | combination of features |
| | | | to be associated with a |
| | | | RA partition |
| | | | Configuration as |
| | | | specified in TS 38.311. |
| UL PRACH slice | O | 0 . . . <maxnoofNSAGs> | |
| group Configuration | | | |
| Item | | | |
| >Slice Group ID | | INTEGER (0 . . . | |
| | | maxNrofSliceGroups, . . . ) | |
| >>startPreambleForThisPar- | O | | INTEGER (1 . . . 64) |
| tition | | | |
| >>numberOfPreambles | O | | INTEGER (1 . . . 64) |
| ForThisPartition | | | |
| >>raFeatureTypePriorities | O | | |
| SUL PRACH | O | | NR PRACH |
| Configuration | | | Configuration List |
| | | | 9.3.1.140 |

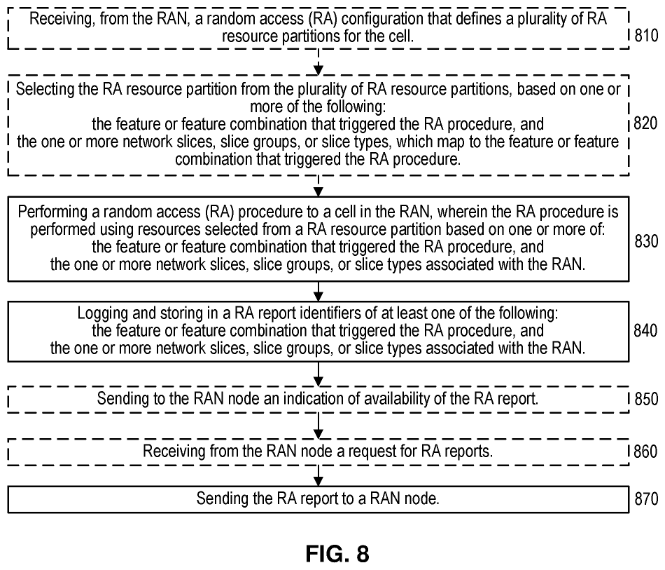

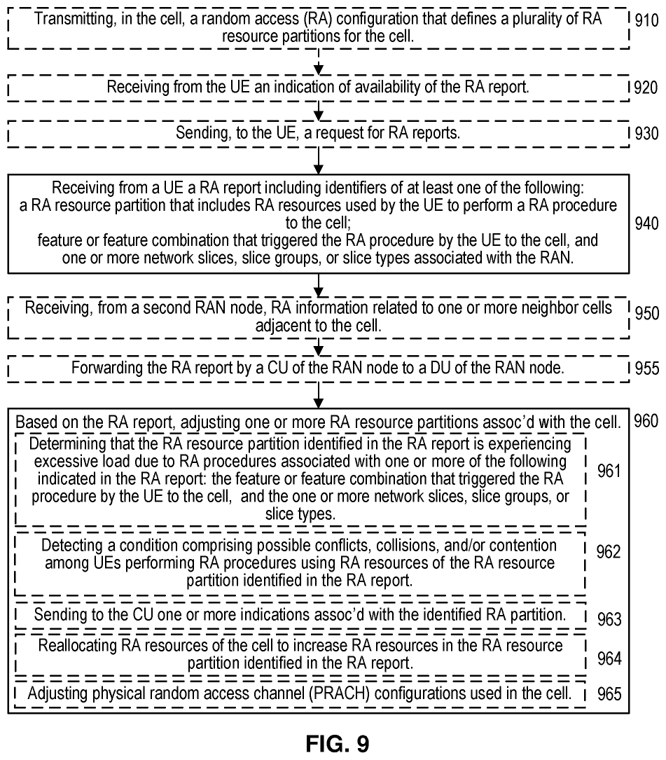

Various features of the embodiments described above correspond to various operations illustrated in FIGS. 8-9, which show exemplary methods (e.g., procedures) for a UE and a RAN node, respectively. In other words, various features of the operations described below correspond to various embodiments described above. Furthermore, the exemplary methods shown in FIGS. 8-9 can be used cooperatively to provide various benefits, advantages, and/or solutions to problems described herein. Although FIGS. 8-9 show specific blocks in particular orders, the 10 operations of the exemplary methods can be performed in different orders than shown and can be combined and/or divided into blocks having different functionality than shown. Optional blocks or operations are indicated by dashed lines.

In particular, FIG. 8 shows an exemplary method (e.g., procedure) for a UE configured to operate in a RAN, according to various embodiments of the present disclosure. The exemplary method can be performed by a UE (e.g., wireless device) such as described elsewhere herein.

The exemplary method can include the operations of block 830, where the UE can perform a random access (RA) procedure to a cell in the RAN. The RA procedure is performed using resources selected from a RA resource partition based on one or more of the following: a feature or feature combination that triggered the RA procedure, and one or more network slices, slice groups, or slice types associated with the RAN. The exemplary method can also include the operations of block 840, where the UE can log and store in a RA report identifiers of at least one of the following: the RA partition, the feature or feature combination that triggered the RA procedure, and the one or more network slices, slice groups, or slice types associated with the RAN. The exemplary method can also include the operations of block 870, where the UE can send the RA report to a RAN node.

In some embodiments, the exemplary method can also include the operations of blocks 810-820, where the UE can receive from the RAN (e.g., in broadcast SI) a RA configuration that defines a plurality of RA resource partitions for the cell, and select the RA resource partition from the plurality of RA resource partitions, based on one or more of the following: the feature or feature combination that triggered the RA procedure, and the one or more network slices, slice groups, or slice types, which map to the feature or feature combination that triggered the RA procedure.

In some of these embodiments, the plurality of RA resource partitions include the following:
at least one RA resource partition of contention-based preamble resources (CBPR) that are dedicated to one or more network slices, slice groups, or slice types associated with the RAN; and
one or more of the following: at least one other partition of CBPR, and at least one partition of contention-free preamble resources (CFPR).

In some embodiments, the UE logs and stores in the RA report respective priorities of one of the following: the feature that triggered the RA procedure, or a plurality of features comprising the feature combination that triggered the RA procedure. In other embodiments, the UE logs and stores in the RA report a highest priority among respective priorities of a plurality of features comprising the feature combination that triggered the RA procedure.

In some embodiments, the identifier of the RA resource partition (i.e., in the RA report) includes the following: an index of an initial RA preamble of the RA resource partition, and a number of RA preambles included in the RA resource partition. In some embodiments, the identifier of the feature or feature combination is a bit field comprising a plurality of bits corresponding to a respective plurality of features or services, with each bit having a value indicating whether the RA procedure was triggered by the corresponding feature or service.

In some embodiments, the exemplary method can also include the operations of block 860, where the UE can receive from the RAN node a request for RA reports. The RA report is sent (e.g., in block 870) in response to the request. In some of these embodiments, the request is an RRC UEInformationRequest message and the RA report is selectively included in a responsive RRC UEInformationResponse message based on the RA report being related to one of the following:
a network slice, slice group, or slice type supported by the RAN node; or
the network slice in which the UE receives the RRC UEInformationRequest message.

In some of these embodiments, the exemplary method can also include the operations of block 850, where the UE can send to the RAN node an indication of availability of the RA report. The request is received in block 860 in response to the indication of availability. In some variants of these embodiments, sending the indication of availability in block 850 is based on the RA report being related to a network slice that is or will be used by the UE to communicate with the RAN node.

In some embodiments, the RAN node serves the cell in which the UE performed the RA procedure.

In addition, FIG. 9 shows an exemplary method (e.g., procedure) for a RAN node configured serve UEs via a cell, according to various embodiments of the present disclosure. The exemplary method can be performed by a RAN node (e.g., base station, eNB, gNB, ng-eNB, etc.) such as described elsewhere herein.

The exemplary method can include the operations of block 940, where the RAN node can receive, from a UE, a RA report including identifiers of at least one of the following:
a RA resource partition that includes RA resources used by the UE to perform a RA procedure to the cell;
a feature or feature combination that triggered the RA procedure by the UE to the cell, and
one or more network slices, slice groups, or slice types associated with the RAN.
   The exemplary method can also include the operations of block 960, where based on the RA report, the RAN node can adjust one or more RA resource partitions associated with the cell.

In some embodiments, the exemplary method can also include the operations of block 910, where the RAN node can transmit in the cell (e.g., via broadcast SI) a RA configuration that defines a plurality of RA resource partitions for the cell, including the RA resource partition identified in the RA report. In some of these embodiments, the RA resource partition identified in the RA report is associated with one or more of the following:
the feature or feature combination that triggered the RA procedure by the UE, and
the one or more network slices, slice groups, or slice types, which map to the feature or feature combination that triggered the RA procedure by the UE.

In some of these embodiments, the plurality of RA resource partitions include the following:
at least one RA resource partition of contention-based preamble resources (CBPR) that are dedicated to one or more network slices, slice groups, or slice types associated with the RAN; and
one or more of the following: at least one other partition of CBPR, and at least one partition of contention-free preamble resources (CFPR).

In some embodiments, the RA report also includes one of the following:
respective priorities of the one or more features or services for which the UE is accessing the RAN; or
a highest priority among the one or more features or services for which the UE is accessing the RAN.

In some embodiments, the identifier of the RA resource partition includes the following: an index of an initial RA preamble of the RA resource partition (i.e., that includes RA resources used by the UE to perform the RA procedure to the cell), and a number of RA preambles included in the RA resource partition.

In some embodiments, the RA report includes respective priorities of one of the following: the feature that triggered the RA procedure, or a plurality of features comprising the feature combination that triggered the RA procedure. In other embodiments, the RA report includes a highest priority among respective priorities of a plurality of features comprising the feature combination that triggered the RA procedure.

In some embodiments, the identifier of the feature or feature combination is a bit field comprising a plurality of bits corresponding to a respective plurality of features or services, with each bit having a value indicating whether the RA procedure was triggered by the corresponding feature or service.

In some embodiments, the exemplary method can also include the operations of block 930, where the RAN node can send to the UE a request for RA reports. The RA report is received from the UE (e.g., in block 940) in response to the request. In some of these embodiments, the request is an RRC UEInformationRequest message and the RA report is selectively received in a responsive RRC UJEInformationResponse message based on the RA report being related to one of the following: a network slice, slice group, or slice type supported by the RAN node; or the network slice in which the RAN node sends the RRC UEInformationRequest message.

In some of these embodiments, the exemplary method can also include the operations of block 920, where the RAN node can receive from the UE an indication of availability of the RA report. The request is sent to the UE in block 930 in response to the indication of availability. In some of these embodiments, receiving the indication of availability in block 920 is based on the RA report being related to a network slice that is or will be used by the UE to communicate with the RAN node.

In some embodiments, adjusting one or more LBT configuration parameters for UEs based on the RA information in block 960 can include the RAN node performing the following operations, labelled with corresponding sub-block numbers:
(961) determining that the RA resource partition identified in the RA report is experiencing excessive load due to RA procedures associated with one or more of the following indicated in the RA report: the feature or feature combination that triggered the RA procedure by the UE to the cell, and the one or more network slices, slice groups, or slice types; and
(962) detecting a condition comprising possible conflicts, collisions, and/or contention among UEs performing RA procedures using RA resources of the RA resource partition identified in the RA report.

In some of these embodiments, adjusting one or more LBT configuration parameters for UEs based on the RA information in block 960 can also include the RAN node performing the following operations, labelled with corresponding sub-block numbers:
(964) reallocating RA resources of the cell to increase RA resources included in the first RA resource partition; and
(965) adjusting PRACH configurations used in the cell.

In some of these embodiments, the RA report is received by a CU of the RAN node and the exemplary method can also include the operations of block 955, where the CU can forward the RA report to a DU of the RAN node. In such case, adjusting one or more RA resource partitions in block 960 is performed by the DU based on the RA report.

In some variants of these embodiments, the condition is detected (e.g., in sub-block 962) by the DU based on a plurality of RA reports received by the CU and forwarded to the DU (e.g., in block 955). Also, adjusting one or more RA resource partitions associated with the cell based on the RA report in block 960 also includes the operations of sub-block 963, where the DU can send to the CU indications of one or more of the following:
the RA resource partition identified in the RA report, in which the condition was detected;
a UE RACH configuration associated with the RA resource partition identified in the RA report;
a cell physical RACH (PRACH) configuration associated with the RA resource partition identified in the RA report; and
load information for the RA resource partition identified in the RA report.
   In some further variants of these embodiments, the load information includes one or more of the following: average number of detected preambles per PRACH occasion, number of RA preambles detected during each of a most recent plurality of PRACH occasions, number of PRACH occasions in which RA preambles were detected, and number of detected RA preambles that could not be processed due to capacity constraints.

In some embodiments, the exemplary method can also include the operations of block 950, where the RAN node can receive, from a second RAN node, RA information related to one or more neighbor cells adjacent to the cell. The RA information for each neighbor cell includes one or more of the following:
a configuration of a plurality of RA resource partitions used in the RA resource partition identified in the RA report;
load information related to the plurality of RA resources partitions; and
a mapping between the plurality of RA resource partitions and a corresponding plurality of one or more of the following: features; services; and network slices, slice groups, or slice types.
   In such embodiments, adjusting the one or more RA resource partitions associated with the cell in block 960 is further based on the RA information received from the second RAN node in block 950.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

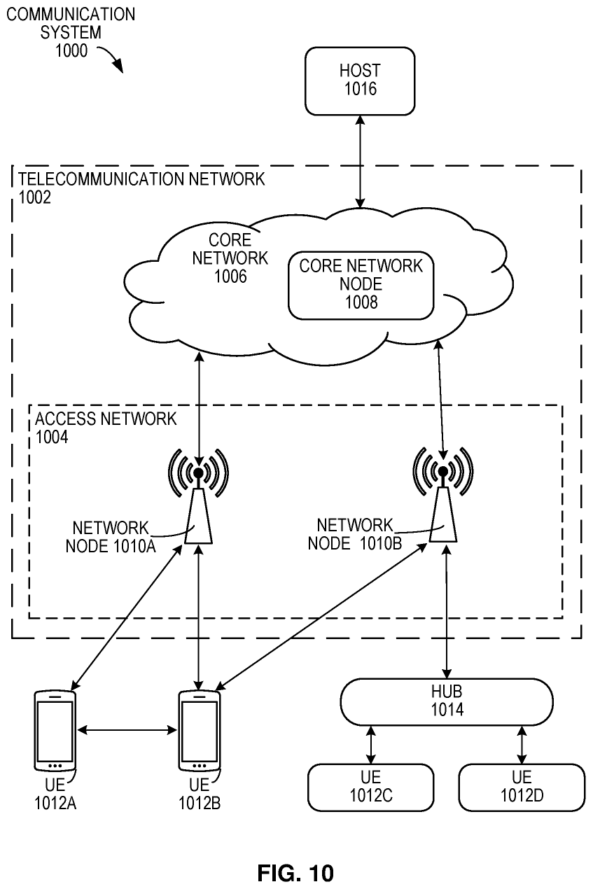

FIG. 10 shows an example of a communication system 1000 in accordance with some embodiments. In this example, communication system 1000 includes a telecommunication network 1002 that includes an access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, the core network 1006 connects network nodes 1010 to one or more hosts, such as host 1016. These connections may be direct or indirect via one or more intermediary networks or devices. In other examples, network nodes may be directly coupled to hosts. The core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to the core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, such as when one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., UE 1012c and/or 1012d), and between hub 1014 and the core network 1006. In other examples, hub 1014 is connected to the core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

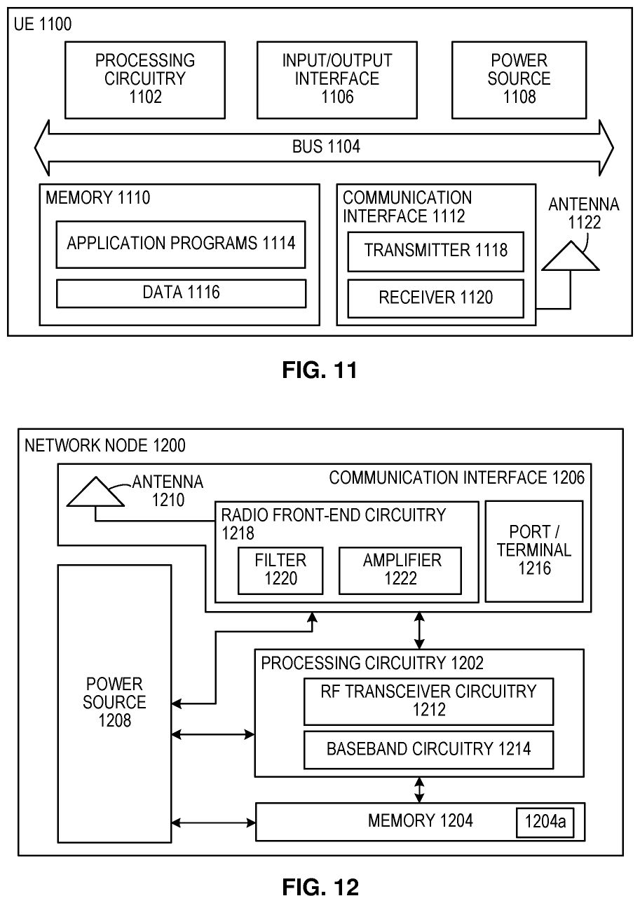

FIG. 11 shows a UE 1100 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, transmitter 1118 and receiver 1120 may be coupled to one or more antennas (e.g., antenna 1122) and may share circuit components, software, or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collectively denoted computer program 1204a, which may be in the form of a computer program product) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210) may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

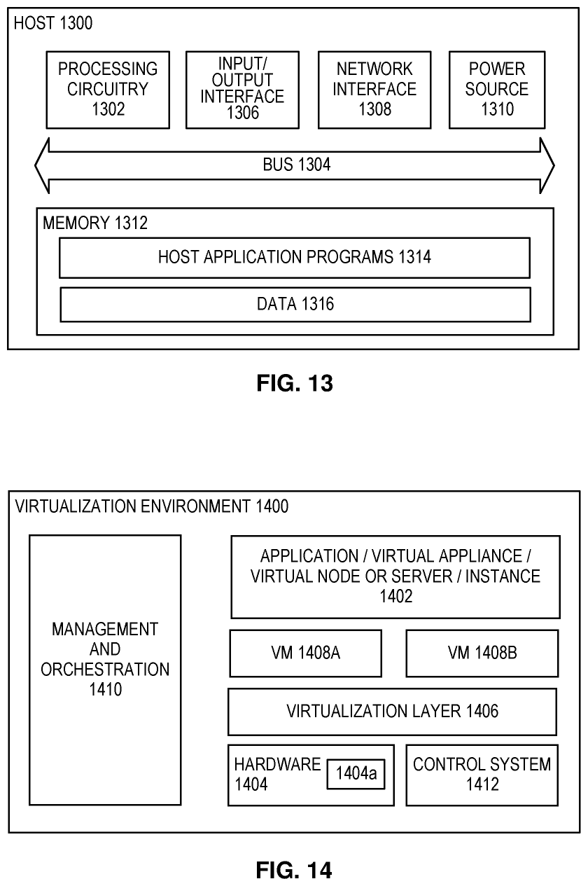

FIG. 13 is a block diagram of a host 1300, which may be an embodiment of host 1016 of FIG. 10, in accordance with various aspects described herein. Host 1300 may be or comprise various combinations of hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (collectively denoted computer program 1404a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

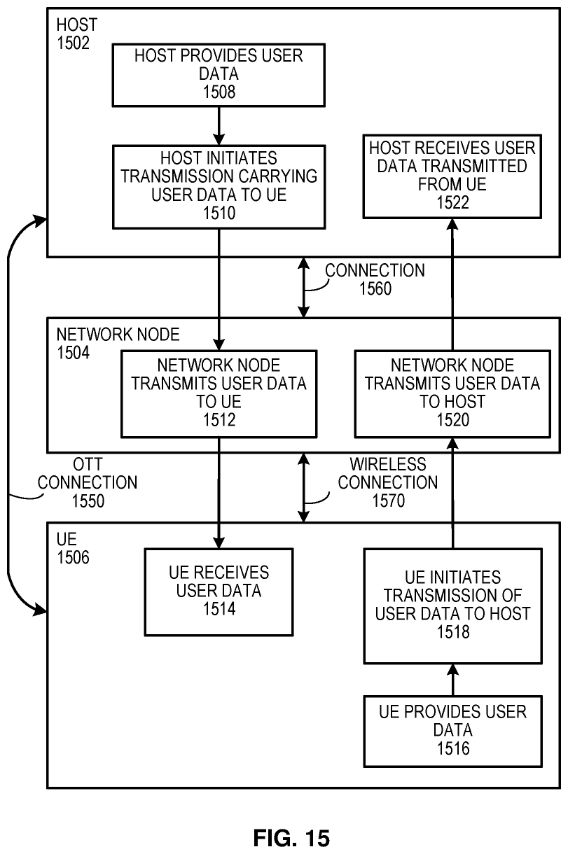

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550).

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550) may extend via a connection 1560 between host 1502 and network node 1504 and via wireless connection 1570) between network node 1504 and UE 1506 to provide the connection between host 1502 and UE 1506. Connection 1560 and wireless connection 1570), over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570) forms the last segment. More precisely, embodiments may improve operation of UEs and RAN nodes in unlicensed spectrum. For example, based on RA information logged and reported by a UE, the RAN can determine whether and how to reconfigure RA resource partitions directly associated with one or more network slices and/or features, as well as RA resource partitions indirectly associated with one or more network slices and/or features due to selection by UEs to perform RA associated with the one or more network slices and/or features. In this manner, the RAN can adjust and/or optimize RA resource partitions in various cells of the RAN, including reallocating resources among multiple RA resource partitions for a cell (e.g., to balance load) and coordinate with other RAN nodes serving neighbor cells to reduce and/or avoid contention and/or conflict among RA resources. These improvements can lead to better performance of the RAN when used to deliver OTT services to end users, which increases the value of such services to end users and service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency, and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured to operate in a radio access network (RAN), the method comprising:
selecting resources from a first random access (RA) resource partition associated with one or more of the following:
   one or more features or services for which the UE is accessing the RAN, and
   one or more network slices, slice groups, or slice types associated with the RAN; using the selected resources, performing a RA procedure to a cell in the RAN; and
sending, to a RAN node, a RA report including identifiers of at least one of the following: the one or more features or services; the one or more network slices, slice groups, or slice types; and the first RA resource partition.

A2. The method of embodiment A1, further comprising:
receiving, from the RAN, a RA configuration that defines a plurality of RA resource partitions for the cell; and
selecting the first RA resource partition from the plurality of RA resource partitions, based on one or more of the following:
   the one or more features or services for which the UE is accessing the RAN, and
   the one or more network slices, slice groups, or slice types, which map to the one or more features or services.

A3. The method of embodiment A2, wherein selecting resources from the first RA resource partition is based on one or more of the following:
the one or more features or services for which the UE is accessing the RAN, and
the one or more network slices, slice groups, or slice types, which map to the one or more features or services.

A4. The method of any of embodiments A2-A3, wherein the plurality of RA resource partitions include the following:
at least one RA resource partition of contention-based preamble resources (CBPR) that are dedicated to one or more network slices, slice groups, or slice types associated with the RAN; and
one or more of the following:
   at least one other partition of CBPR; and
   at least one partition of contention-free preamble resources (CFPR).

A5. The method of any of embodiments A1-A4, wherein the RA report also includes one of the following:
respective priorities of the one or more features or services for which the UE is accessing the RAN; or
a highest priority among the one or more features or services for which the UE is accessing the RAN.

A6. The method of any of embodiments A1-A5, wherein the identifier of the first RA resource partition includes the following: an index of an initial RA preamble of the first RA resource partition, and a number of RA preambles included in the first RA resource partition.

A7. The method of any of embodiments A1-A6, wherein the identifier of the one or more features or services is a bit field comprising a plurality of bits corresponding to a respective plurality of features or services, with each bit having a value indicating whether the UE was accessing the RAN for the corresponding feature or service.

A8. The method of any of embodiments A1-A7, further comprising receiving, from the RAN node, a request for RA reports, wherein the RA report is sent in response to the request.

A9. The method of embodiment A8, wherein the request is an RRC UEInformationRequest message and the RA report is selectively included in a responsive RRC UEInformationResponse message based on the RA report being related to one of the following:
a network slice, slice group, or slice type supported by the RAN node; or
the network slice in which the UE receives the RRC UEInformationRequest message.

A10. The method of any of embodiments A8-A9, further comprising sending, to the RAN node, an indication of availability of the RA report, wherein the request is received in response to the indication of availability.

A11. The method of embodiment A10, wherein sending the indication of availability is based on the RA report being related to a network slice that is or will be used by the UE to communicate with the RAN node.

A12. The method of any of embodiments A1-A11, wherein the RAN node serves the cell in which the UE performed the RA procedure.

B1. A method for a radio access network (RAN) node configured to serve user equipment (UEs) via a cell, the method comprising:
receiving, from a UE, a random access (RA) report including identifiers of at least one of the following:
   one or more features or services for which the UE accessed the RAN via a cell,
   one or more network slices, slice groups, or slice types associated with the RAN, and
   a first RA resource partition, associated with the cell, that includes RA resources used by the UE to perform a RA procedure towards the cell; and
based on the RA report, adjusting one or more RA resource partitions associated with the cell.

B2. The method of embodiment B2, further comprising transmitting, in the cell, a RA configuration that defines a plurality of RA resource partitions for the cell, including the first RA resource partition.

B3. The method of embodiment B2, wherein the plurality of RA resource partitions include the following:
at least one RA resource partition of contention-based preamble resources (CBPR) that are dedicated to one or more network slices, slice groups, or slice types associated with the RAN; and
one or more of the following:
   at least one other partition of contention-based preamble resources (CBPR); and
   at least one partition of contention-free preamble resources (CFPR).

B4. The method of any of embodiments B1-B3, wherein the RA report also includes one of the following:
respective priorities of the one or more features or services for which the UE is accessing the RAN; or
a highest priority among the one or more features or services for which the UE is accessing the RAN.

B5. The method of any of embodiments B1-B4, wherein the identifier of the first RA resource partition includes the following: an index of an initial RA preamble of the first RA resource partition, and a number of RA preambles included in the first RA resource partition.

B6. The method of any of embodiments B1-B5, wherein the identifier of the one or more features or services is a bit field comprising a plurality of bits corresponding to a respective plurality of features or services, with each bit having a value indicating whether the UE was accessing the RAN for the corresponding feature or service.

B7. The method of any of embodiments B1-B6, further comprising sending, to the UE, a request for RA reports, wherein the RA report is received in response to the request.

B8. The method of embodiment B7, wherein the request is an RRC UEInformationRequest message and the RA report is selectively received in a responsive RRC UEInformationResponse message based on the RA report being related to one of the following:
a network slice, slice group, or slice type supported by the RAN node; or
the network slice in which the RAN node transmits the RRC UEInformationRequest message.

B9. The method of any of embodiments B7-B8, further comprising receiving, from the UE, an indication of availability of an RA report associated with an RA procedure performed by the UE, wherein the request is sent in response to the indication of availability.

B10. The method of embodiment B9, wherein receiving the indication of availability is based on the RA report being related to a network slice that is or will be used by the UE to communicate with the RAN node.

B11. The method of any of embodiments B1-B10, wherein adjusting the one or more RA resource partitions associated with the cell based on the RA report comprises one or more of the following:
determining that the first RA resource partition is experiencing excessive load due to RA procedures associated with one or more of the following indicated in the RA report: the one or more features or services; and the one or more network slices, slice groups, or slice types; and
detecting possible conflicts, collisions, and/or contention among UEs performing RA procedures using resources of the first RA resource partition.

B12. The method of embodiment B11, wherein adjusting one or more RA resource partitions associated with the cell based on the RA report further comprises one or more of the following:
reallocating RA resources of the cell to increase RA resources included in the first RA resource partition; and
adjusting physical random access channel (PRACH) configurations used in the cell.

B13. The method of any of embodiments B1-B12, further comprising receiving, from a second RAN node, RA information related to one or more neighbor cells adjacent to the cell, wherein the RA information for each neighbor cell includes one or more of the following:
a configuration of a plurality of RA resource partitions used in the neighbor cell;
load information related to the plurality of RA resources partitions; and
a mapping between the plurality of RA resource partitions and a corresponding plurality of one or more of the following: features; services; and network slices, slice groups, or slice types.

B14. The method of embodiment B13, wherein adjusting the one or more RA resource partitions associated with the cell is further based on the RA information received from the second RAN node.

B15. The method of any of embodiments B1-B14, wherein adjusting the one or more RA resource partitions associated with the cell based on the RA report is performed by one of the following: a central unit (CU) of the RAN node, which receives the RA report; or a distributed unit (DU) of the RAN node, which serves the cell.

C1. A user equipment (UE) configured to operate in unlicensed spectrum in a radio access network (RAN), the UE comprising:
communication interface circuitry configured to communicate with at least one RAN node; and
processing circuitry operatively coupled to the communication interface circuitry, whereby the processing circuitry and the communication interface circuitry are configured to perform operations corresponding to the methods of any of embodiments A1-A12.

C2. A user equipment (UE) configured to operate in unlicensed spectrum in a radio access network (RAN), the UE being further arranged to perform operations corresponding to the methods of any of embodiments A1-A12.

C3. A non-transitory, computer-readable medium storing computer-executable instructions that, when executed by processing circuitry of a user equipment (UE) configured to operate in unlicensed spectrum in a radio access network (RAN), configure the UE to perform operations corresponding to the methods of any of embodiments A1-A12.

C4. A computer program product comprising computer-executable instructions that, when executed by processing circuitry of a user equipment (UE) configured to operate in unlicensed spectrum in a radio access network (RAN), configure the UE to perform operations corresponding to the methods of any of embodiments A1-A12.

D1. A radio access network (RAN) node configured to serve user equipment (UEs) via a cell in unlicensed spectrum, the RAN node comprising:
communication interface circuitry configured to communicate with UEs; and
processing circuitry operatively coupled to the communication interface circuitry, whereby the processing circuitry and the communication interface circuitry are configured to perform operations corresponding to the methods of any of embodiments B1-B15.

D2. A radio access network (RAN) node configured to serve user equipment (UEs) via a cell in unlicensed spectrum, the RAN node being further arranged to perform operations corresponding to the methods of any of embodiments B1-B15.

D3. A non-transitory, computer-readable medium storing computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B15.

D4. A computer program product comprising computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B15.

1-42. (canceled)

43. A method for a user equipment (UE) configured to operate in a radio access network (RAN), the method comprising:
performing a random access (RA) procedure to a cell in the RAN, wherein the RA procedure is performed using resources selected from a RA resource partition based on one or more of the following:
a feature or feature combination that triggered the RA procedure, and
one or more network slices, slice groups, or slice types associated with the RAN;
logging and storing in a RA report identifiers of at least one of the following:
the RA partition,
the feature or feature combination that triggered the RA procedure, and
the one or more network slices, slice groups, or slice types associated with the RAN; and
sending the RA report to a RAN node.

44. The method of claim 43, further comprising:
receiving, from the RAN, a RA configuration that defines a plurality of RA resource partitions for the cell; and
selecting the RA resource partition from the plurality of RA resource partitions, based on one or more of the following:
the feature or feature combination that triggered the RA procedure, and
the one or more network slices, slice groups, or slice types, which map to the feature or feature combination that triggered the RA procedure.

45. The method of claim 44, wherein the plurality of RA resource partitions include the following:
at least one RA resource partition of contention-based preamble resources (CBPR) that are dedicated to one or more network slices, slice groups, or slice types associated with the RAN; and
one or more of the following:
at least one other partition of CBPR; and
at least one partition of contention-free preamble resources (CFPR).

46. The method of claim 43, wherein the UE logs and stores in the RA report one of the following:
a priority of the feature that triggered the RA procedure,
respective priorities a plurality of features comprising the feature combination that triggered the RA procedure, or
a highest priority among respective priorities of a plurality of features comprising the feature combination that triggered the RA procedure.

47. The method of claim 43, wherein the identifier of the RA resource partition includes the following: an index of an initial RA preamble of the RA resource partition, and a number of RA preambles included in the RA resource partition.

48. The method of claim 43, wherein the identifier of the feature or feature combination is a bit field comprising a plurality of bits corresponding to a respective plurality of features or services, with each bit having a value indicating whether the RA procedure was triggered by the corresponding feature or service.

49. The method of claim 43, further comprising receiving from the RAN node a request for RA reports, wherein the RA report is sent in response to the request.

50. The method of claim 49, wherein the request is an RRC UEInformationRequest message and the RA report is selectively included in a responsive RRC UEInformationResponse message based on the RA report being related to one of the following:
a network slice, slice group, or slice type supported by the RAN node; or
the network slice in which the UE receives the RRC UEInformationRequest message.

51. The method of claim 49, further comprising sending to the RAN node an indication of availability of the RA report, wherein the request is received in response to the indication of availability.

52. The method of claim 51, wherein sending the indication of availability is based on the RA report being related to a network slice that is or will be used by the UE to communicate with the RAN node.

53. The method of claim 43, wherein the RAN node serves the cell in which the UE performed the RA procedure.

54. A method for a radio access network (RAN) node configured to serve user equipment (UEs) via a cell, the method comprising:
receiving, from a UE, a random access (RA) report including identifiers of at least one of the following:
a RA resource partition that includes RA resources used by the UE to perform a RA procedure to the cell;
a feature or feature combination that triggered the RA procedure by the UE to the cell, and
one or more network slices, slice groups, or slice types associated with the RAN; and
based on the RA report, adjusting one or more RA resource partitions associated with the cell.

55. The method of claim 54, further comprising transmitting, in the cell, a RA configuration that defines a plurality of RA resource partitions for the cell, including the RA resource partition identified in the RA report.

56. The method of claim 55, wherein the RA resource partition identified in the RA report is associated with one or more of the following:
the feature or feature combination that triggered the RA procedure by the UE, and
the one or more network slices, slice groups, or slice types, which map to the feature or feature combination that triggered the RA procedure by the UE.

57. The method of claim 55, wherein the plurality of RA resource partitions include the following:
at least one RA resource partition of contention-based preamble resources (CBPR) that are dedicated to one or more network slices, slice groups, or slice types associated with the RAN; and
one or more of the following:
at least one other partition of CBPR; and
at least one partition of contention-free preamble resources (CFPR).

58. The method of claim 54, wherein the identifier of the RA resource partition includes the following: an index of an initial RA preamble of the RA resource partition, and a number of RA preambles included in the RA resource partition.

59. The method of claim 54, wherein the RA report also includes one of the following:
a priority of the feature that triggered the RA procedure,
respective priorities a plurality of features comprising the feature combination that triggered the RA procedure, or
a highest priority among respective priorities of a plurality of features comprising the feature combination that triggered the RA procedure.

60. The method of claim 54, wherein the identifier of the feature or feature combination is a bit field comprising a plurality of bits corresponding to a respective plurality of features or services, with each bit having a value indicating whether the RA procedure was triggered by the corresponding feature or service.

61. The method of claim 54, further comprising sending to the UE a request for RA reports, wherein the RA report is received in response to the request.

62. The method of claim 61, wherein the request is an RRC UEInformationRequest message and the RA report is selectively received in a responsive RRC UEInformationResponse message based on the RA report being related to one of the following:
a network slice, slice group, or slice type supported by the RAN node; or
the network slice in which the RAN node sends the RRC UEInformationRequest message.

63. A user equipment (UE) configured to operate in a radio access network (RAN), the UE comprising:
communication interface circuitry configured to communicate with at least one RAN node; and
processing circuitry operatively coupled to the communication interface circuitry, wherein the processing circuitry and the communication interface circuitry are configured to:
perform a random access (RA) procedure to a cell in the RAN, wherein the RA procedure is performed using resources selected from a RA resource partition based on one or more of the following:
a feature or feature combination that triggered the RA procedure, and
one or more network slices, slice groups, or slice types associated with the RAN;
log and store in a RA report identifiers of at least one of the following:
the RA partition,
the feature or feature combination that triggered the RA procedure, and
the one or more network slices, slice groups, or slice types associated with the RAN; and
send the RA report to the RAN node.

64. The UE of claim 63, wherein one or more of the following applies:
the identifier of the RA resource partition includes the following: an index of an initial RA preamble of the RA resource partition, and a number of RA preambles included in the RA resource partition; and
the UE logs and stores in the RA report one of the following:
a priority of the feature that triggered the RA procedure,
respective priorities a plurality of features comprising the feature combination that triggered the RA procedure, or
a highest priority among respective priorities of a plurality of features comprising the feature combination that triggered the RA procedure.

65. A radio access network (RAN) node configured to serve user equipment (UEs) via a cell, the RAN node comprising:
communication interface circuitry configured to communicate with UEs via the cell; and
processing circuitry operatively coupled to the communication interface circuitry, wherein the processing circuitry and the communication interface circuitry are configured to:
receive, from a UE, a random access (RA) report including identifiers of at least one of the following:
a feature or feature combination that triggered a RA procedure by the UE to the cell, and
one or more network slices, slice groups, or slice types associated with the RAN; and
based on the RA report, adjust one or more RA resource partitions associated with the cell.

66. The RAN node of claim 65, wherein one or more of the following applies:
the identifier of the RA resource partition includes the following: an index of an initial RA preamble of the RA resource partition, and a number of RA preambles included in the RA resource partition; and
the RA report also includes one of the following:
a priority of the feature that triggered the RA procedure,
respective priorities a plurality of features comprising the feature combination that triggered the RA procedure, or
a highest priority among respective priorities of a plurality of features comprising the feature combination that triggered the RA procedure.
